(19) United States
(12) Patent Application Publication
(10) Pub. No.: US 2012/0291693 A1
(43) Pub. Date: Nov. 22, 2012

(54) BADGE HOLDER WITH WHISTLE FUNCTION

(76) Inventor: Chin-San CHENG, Changhua City (TW)

(21) Appl. No.: 13/109,394

(22) Filed: May 17, 2011

(51) Int. Cl. G10K 5/00

(52) U.S. Cl. 116/2

(57) ABSTRACT

A badge holder with a whistle function includes a body and a cover, wherein the body includes a protecting part for receiving the badges. A fixing part is formed at one peripheral side of the protecting part. A cover sealed with the fixing part for forming a hollow part between the fixing part and the cover. The fixing part and the cover together form a blowing part. A blowing passage, a retaining wall and a resonance chamber are formed within the fixing part and cover. Thus. when wearing it, a user can blow the blowing part to make a whistle sound.

### BACKGROUND

1. Technical Field

The present invention relates to a badge holder. More particularly, the present invention relates to a badge holder with a whistle function.

2. Related Art

A common badge holder is for preventing the badges from damage, which is in a form of a flat envelope. The badges include such as identification badges, security badges and the like. However, the common badge holder is merely for preventing the badge from damage. When an emergency situation and a situation needed an immediate attention happened, it needs a whistle. For example, guards, activity leaders, emergency happening, handicapped and dementia elders usually need to carry whistles. Furthermore, when a user wears a badge holder and a whistle at the same time, the lanyards thereof are easily to tangle together, inconvenient to keep and hardly to take off from the necks. Moreover, the cost for a badge holder and a whistle in two pieces is higher than in one piece.

### BRIEF SUMMARY

Therefore, in view of the insufficiencies of the common badge holder and whistle in actual use, such as hard to keep, inconvenient when using, and higher cost, it demands a new design.

The present invention provides a badge holder with a whistle function, which is easy to keep, convenient to use and cost lower.

The present invention provides a badge holder with a whistle function, which comprises a body comprising a protecting part and a cover, wherein the protecting part includes an opening at one side for receiving the badge and a linking part at the one side of the circumference thereof. A hollow fixing part is provided on the protecting part at the side opposite to the linking part The fixing part provides a blowing part with a blowing passage and a resonance chamber disposed on at least one end thereof. A retaining wall is disposed between the blowing passage and the resonance chamber. The cover peripherally seals with the outer circumference of the fixing par. A blowing hole is provided at the cover and the fixing part at the place corresponding to the blowing passage. The cover and the fixing part are communicated and at least one sound-out hole is formed on the cover at the place corresponding to the retaining wall.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a rear perspective view of one embodiment in accordance with the present invention.

FIG. 2 is a partial cross-sectional rear perspective view of one embodiment in accordance with the present invention the present invention.

FIG. 3 is an exploded rear perspective view of one embodiment in accordance with the present invention.

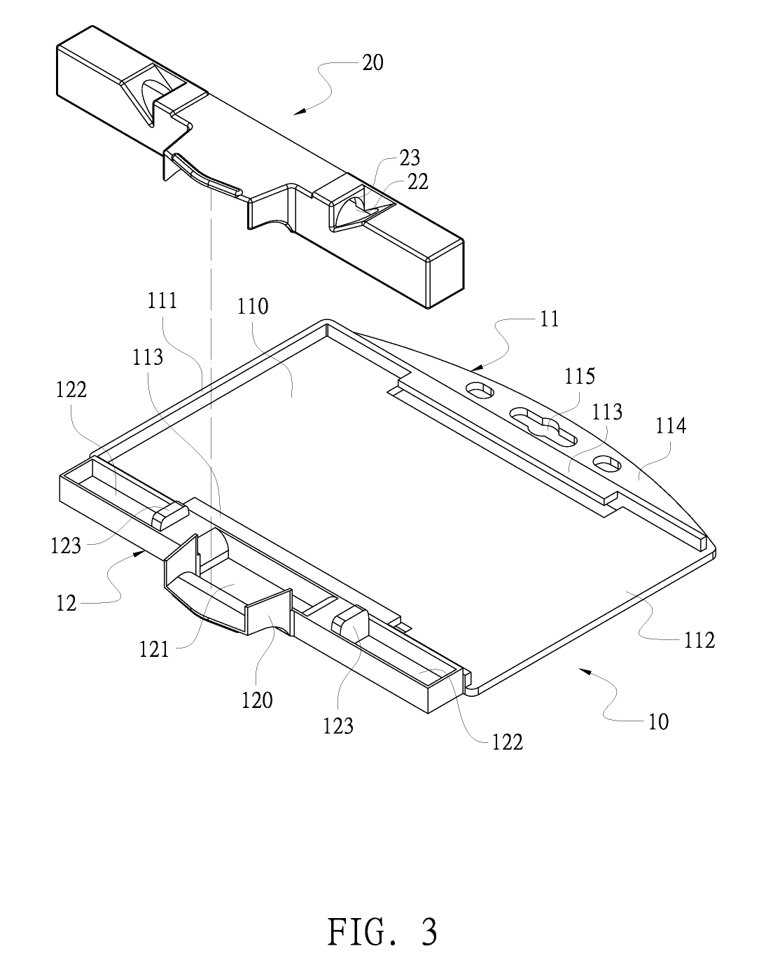

FIG. 4 is a partial cross-sectional front perspective view of one embodiment in accordance with the present invention.

### DETAILED DESCRIPTION

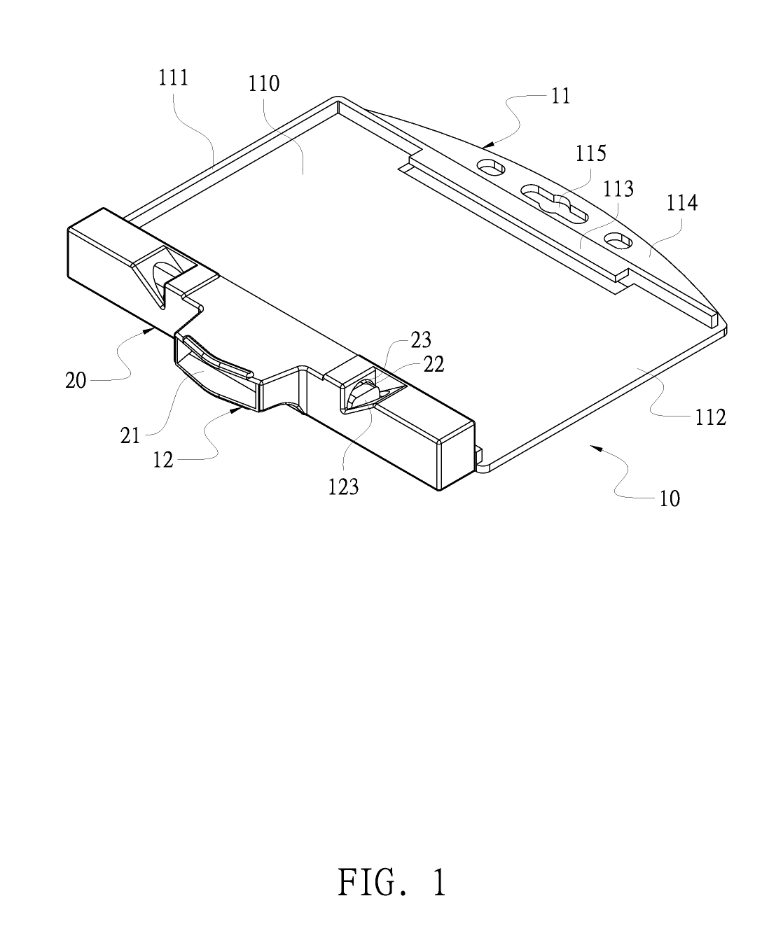

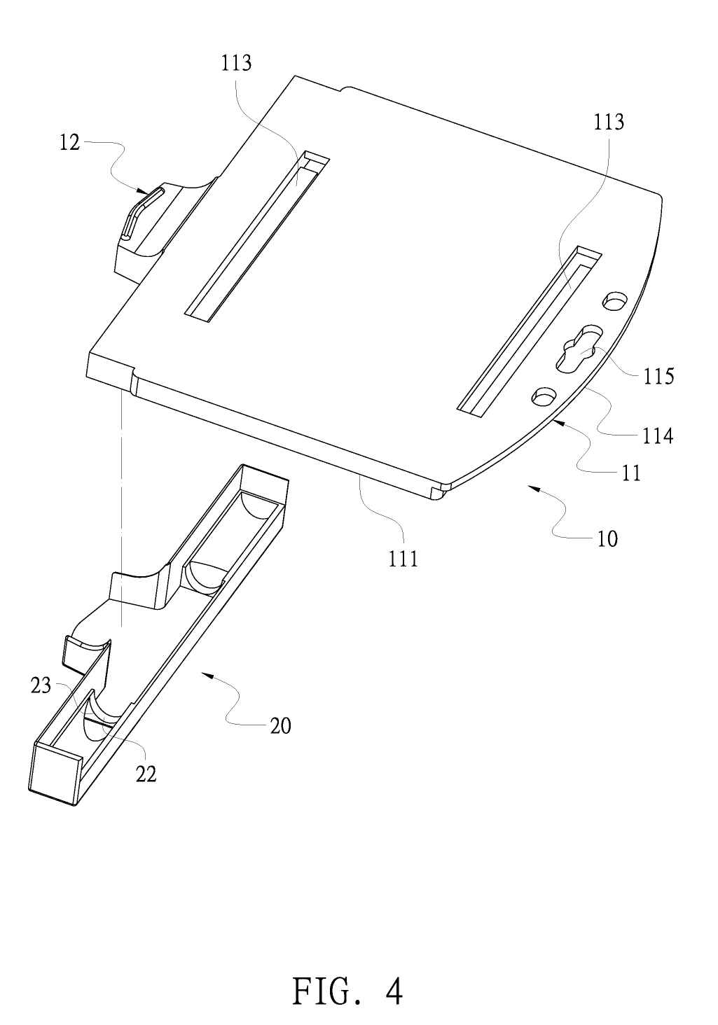

As shown in FIGS. 1, 2 and 4, the present invention provides a badge holder with whistle function comprises:

a body 10 comprising:
a protecting part 11 including a plate 110 with a frame 111, an opening 112 at one side of the frame 111, one side of the protecting body which is other than the side of the opening 112 including two stopper ribs 113 parallel to the plate 110, one side of the protecting part 111 including a linking part 114, the linking part 114 with at least one hole 115;

a hollow fixing part 12 integrating to the protecting part 11 at a side different from the linking part 114, such as at the opposition side as shown in the drawing, wherein the fixing part 12 is formed at the frame 111 of the protecting part 11, the fixing part 12 includes a blowing part' 120, the blowing part 120 includes a blowing passage 121, each of the two ends of the blowing passage 121 has a resonance chamber 122, the sizes of the two resonance chambers 122 can be adjusted for the requiring frequency, these two resonance chambers 122 may have the same or different sizes, a retaining wall 123 is disposed between the blowing passage 121 and the resonance chamber 122;

a hollow cover 20 peripherally sealing with the out circumference of the fixing part 12, wherein the cover 20 and the fixing part 12 at the place corresponding to the blowing passage 121 provide a blowing hole 21, the cover 20 and the fixing part 12 together forms a communication area, the cover 20 at the places corresponding to the two retaining walls 123 provides sound-out holes 22, the sound-out hole 22 of the cover 20 is formed as a semi-circular hole 23 in the direction toward to the retaining wall 123.

Thus, a badge holder with whistle function in accordance with the present invention is formed.

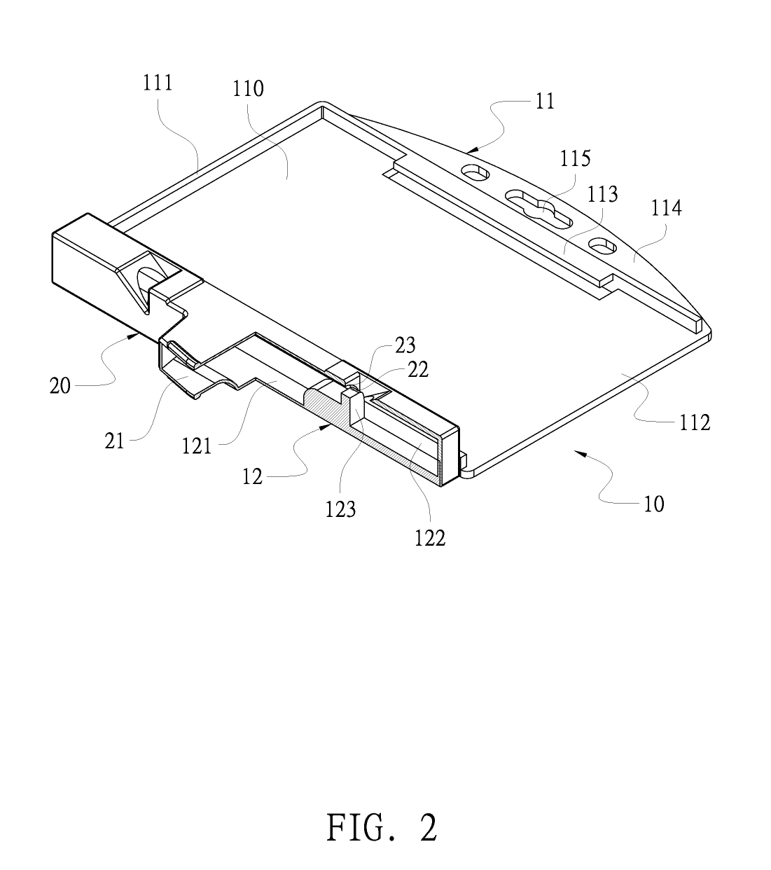

When using, as showing in FIGS. 1 and 2, a user can insert the badge (not shown) from the opening 112 of the protecting part 11 into the area restricted by the frame 111, the two stopper ribs 113 and the plate 110 to hold the badge in order to protect the badge in protecting part 11. When an emergency situation or a situation needed an immediate attention happened, the user can blow to the blowing hole 21. Thus, the air flows from blowing passage 121 through the retaining wall 123 to the two resonance chambers 122 and to the two sound-out holes 22 to make a whistle. Furthermore, in accordance with the size of the resonance chamber 122, the frequency of the whistle can be adjusted. When a user needs a badge holder and a whistle, a badge holder with whistle function of the present invention can provide these two functions in one piece, and avoid the tangle of the lanyards. Furthermore, the present badge holder with whistle function is convenient in use and less costly.

In addition, the fixing part on the present invention is not limited to have two retaining walls and two resonance chambers, one retaining wall and one resonance chamber is also covered in the scope of the present invention. In this embodiment, the cover can be adjusted to fit a fixing part which only has a resonance chamber and a sound-out hole to provide the same whistle function.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A badge holder with whistle function comprising:
a body comprising:
a protecting part including an opening at one side for receiving the badge and a linking part at the one side of the circumference thereof;
a hollow fixing part provided on the protecting part at the side opposite to the linking part, wherein the fixing part provides a blowing part with a blowing passage, a resonance chamber is disposed on at least one end thereof, a retaining wall is disposed between the blowing passage and the resonance chamber blowing passage;
a hollow cover peripherally sealed with the outer circumference of the fixing part, wherein a blowing hole is provided at the cover and the fixing part at the place corresponding to the blowing passage, the cover and the fixing part are communicated and at least one sound-out hole is formed on the cover at the place corresponding to the retaining wall.

2. The badge holder as claimed in claim 1, wherein the protecting part includes a plate with a frame, an opening at one side of the frame, one side of the protecting body which is other than the side of the opening including stopper ribs parallel to the plate.

3. The badge holder as claimed in claim 1, wherein the fixing part is integrally formed on the protecting part at the side opposite to the linking part.

4. The badge holder as claimed in claim 1, wherein a resonance chamber is disposed at the each end of the fixing part, and a retaining wall is disposed between the blowing passage and the two resonance chamber, and two sound-out holes are formed on the cover at the place corresponding to the two retaining walls.

5. The badge holder as claimed in claim 1, wherein the two resonance chambers are in different sizes.

6. The badge holder as claimed in claim 1, wherein the sound-out hole of the cover is formed as a semi-circular hole toward to the retaining wall.

7. The badge holder as claimed in claim 1, wherein the linking part has at least one hole.

8. The badge holder as claimed in claim 1, wherein the fixing part is integrally formed with the protecting part.
